(19) United States
(12) Patent Application Publication
(10) Pub. No.: US 2009/0327719 A1
(43) Pub. Date: Dec. 31, 2009

(54) COMMUNICATION AUTHENTICATION

(75) Inventor: Cormac E. Herley, Bellevue, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/163,517

(22) Filed: Jun. 27, 2008

(51) Int. Cl. H04L 9/00

(52) U.S. Cl. 713/168

(57) ABSTRACT

Systems and methods that establish trust between a receiver (e.g., a user) and a sender of a message by authenticating such sender through demonstration of knowledge for a shared secret—yet without revealing such secret. A messaging component can convey messages as directed by the shared secret to communication systems that are under control of the user. Accordingly, the user can readily determine that the sender of the message is what such sender claims to be, since the sender has demonstrated a knowledge of the shared secret by sending the message to the communication system as determined by the user. Moreover, by not actually revealing the shared secret during communication, robustness of the secret is typically ensured.

### BACKGROUND

Developments in communication technology have changed common protocol for business. There is less in-person communication as people communicate through alternative mediums. For example, electronic mail (e-mail) allows individuals to communicate virtually instantaneously. Real time communications allow individuals to communicate as if they were together even if they are not physically in the same location. For example, employees can communicate though an instant messenger service without ever leaving their desk or personal computer.

As the Internet grows in popularity as a business medium, users engage in a wider variety of transactions online. Some of these transactions, such as transactions with financial institutions or online retailers, can involve sensitive personal information such as bank account numbers or credit card information. To protect such information, a variety of methods can be employed. For example, many online institutions require users to register with the institution and obtain a unique user name and password prior to transacting any business online.

Phishing can generally be described as an attempt by a third party to deceive a user into disclosing his username and password to that third party through the third party's impersonation of an entity that is known and trusted by the user. Generally, a phishing attack can be initiated by sending an electronic mail message to a user that is crafted to appear to originate from a known and trusted entity. Such electronic mail messages commonly inform the recipient that the entity must verify the information of the user by having the user enter his username and password. The user may enter this information at a web site that appears to belong to the known and trusted entity but is actually controlled by a third party. Once the user enters this information at the web site of the third party, sometimes called a phishing site, the third party can use the entered username and password at the real website of the entity that the third party is impersonating to perform transactions or even to wrest control of an account with the known and trusted party away from the user.

Several factors make phishing a challenging problem from a computer security standpoint. First, in phishing attacks the victim unknowingly or unwittingly assists the attacker by voluntarily providing his security credentials such as a username and password to the attacker. Second, identifying phishing sites can be difficult using a fixed algorithm because attackers both quickly adapt to security measures and it is difficult if not impossible to anticipate the ingenuity of all future attackers with a fixed set of rules. Third, users tend to ignore warnings about security dangers. Even the best warnings can be rendered useless by a user who does not heed the warning. The components and methods disclosed and described herein take these factors into account to provide a means for protecting against phishing attacks

### SUMMARY

The following presents a simplified summary in order to provide a basic understanding of some aspects described herein. This summary is not an extensive overview of the claimed subject matter. It is intended to neither identify key or critical elements of the claimed subject matter nor delineate the scope thereof. Its sole purpose is to present some concepts in a simplified form as a prelude to the more detailed description that is presented later.

The subject innovation provides for establishment of trust between a user and a sender of a message by authenticating such sender through demonstration of knowledge for a shared secret—yet without revealing such secret (e.g., a hint)—through a messaging component. Such messaging component can convey messages to communication systems and/or communication accounts, which are under control of the user (e.g., two e-mails that are controlled by the user, a telephone number(s) and an e-mail(s) controlled by a user; and the like), as directed by the shared secret. Accordingly, the user can readily determine that the sender of the message is what such sender claims to be, since the sender has demonstrated a knowledge of the shared secret by sending the message to the communication system as determined by the user—wherein by not revealing the shared secret during communication, robustness of the secret is typically ensured.

In a related aspect, the user can establish a plurality of independent communication accounts (e.g., two e-mails accounts) wherein senders of messages are advised that if a message is sent to the first communication account, a same message has to be sent to other communication accounts, before a user treats such messages as genuine. For example, the shared secret can include transfer of the message to the second e-mail account upon transfer of such message to the first e-mail account. Accordingly, once the sender sends a message to the first e-mail account, a portion of this message can also include that such message has also been sent to the second e-mail (without actually specifying the whole address. e.g., xxxx@hotmail.com). Moreover, the sender sends the message to the second e-mail account. Such compliance with a manner the messages are sent can typically ensure that genuineness of sender, since the shared secret is not readily availed to malicious entities.

In a related aspect, the messaging component can further include a registration component that can store the manner for communication as defined by the shared secret. Such registration component can supply the messaging component the manner to convey messages to communication systems, which are under control of the user (e.g., two e-mails that are controlled by the user, a telephone number(s) and an e-mail(s) controlled by a user; and the like), as directed by the shared secret. The messaging component can further include a sending component that sends the message independently of each other and as directed by the shared secret. Such shared secret provides significant challenge for a malicious entity to obtain information about accounts that are not publicly available (e.g., e-mail aliases).

According to a methodology of the subject innovation, initially a shared secret can be designated by a user. Such shared secret can pertain to identifying a manner of communication to the user—(e.g., message has to be sent to two e-mail addresses, upon sending an e-mail message a telephone number has also to be contacted, and the like.) Next, a user can receive a message purportedly sent from the sender. To verify genuineness of the sender, compliance with the shared message is checked by the user. If compliance is verified, then the user treats the received message as genuine. Otherwise, the received message can be ignored by the user. In a related aspect, the user has access to the registration component for an update thereof regarding the shared secret.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 illustrates a block diagram of a system that demonstrates knowledge of a shared secret without revelation thereof according to an aspect of the subject innovation.

FIG. 2 illustrates a particular system for trust establishment according to an aspect of the subject innovation.

FIG. 3 illustrates a particular aspect of a system that authenticates trust between sender of a message and a user/receiver according to an aspect of the subject innovation.

FIG. 4 illustrates a methodology of establishing a trust between a user and a sender according to a further aspect of the subject innovation.

FIG. 5 illustrates a methodology of sender authentication according to a further aspect of the subject innovation.

FIG. 6 illustrates a particular block diagram for a system that includes notification component according to a further aspect of the subject innovation.

FIG. 7 illustrates an exemplary graphical user interface according to a further aspect of the subject innovation.

FIG. 8 is a schematic block diagram of a sample-computing environment 1000 that can be employed as part of trust establishment in accordance with an aspect of the subject innovation.

FIG. 9 illustrates an exemplary environment for implementing various aspects of the subject innovation.

### DETAILED DESCRIPTION

The various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

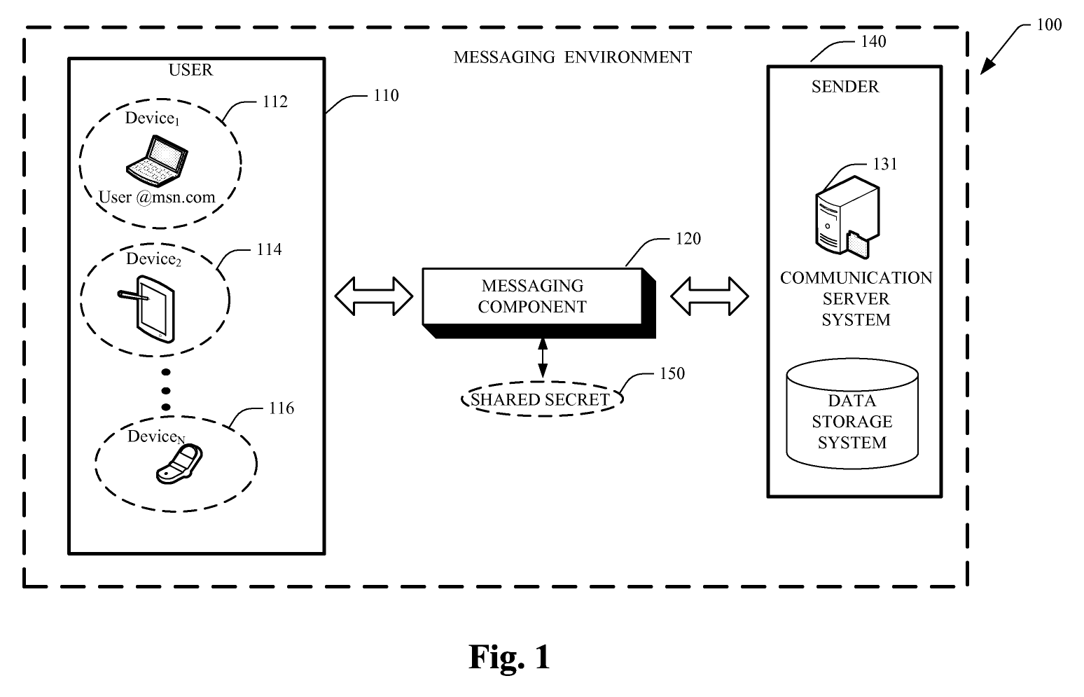

FIG. 1 illustrates a system 100 that enables establishment of trust between a user 110 and a sender 140 of a message by authenticating such sender 140 through demonstration of knowledge for a shared secret 150 (e.g., predetermined)—yet without revealing such secret 150—through a messaging component 120. For example, the sender 140 can be financial institution, e-commerce business and in general, any entity that the user 110 is a client thereof, and messages therefrom can be subject to attack. Moreover, the shared secret can 150 can pertain to a manner that the message sender should communicate with the user 116, e.g., upon sending a message to the e-mail account User@msn.com, also a message is sent to the e-mail account on another internet service provider as specified by the shared secret, which the user has set with the sender 140.

As illustrated in FIG. 1, the user side 110 can include a plurality of devices 112, 114, 116 (1 thru N, where N is an integer), which are under the control of the user 110 and can receive a message(s) from the sender 140. The devices 112, 114, 116 can also be part of a network (e.g., wireless network) such as a system area network or other type of network, and can include several hosts, (not shown), which can be personal computers, servers or other types of computers. Such hosts generally can be capable of running or executing one or more application-level (or user-level) programs, as well as initiating an I/O request (e.g., I/O reads or writes). In addition, the network can be, for example, an Ethernet LAN, a token ring LAN, or other LAN, or a Wide Area Network (WAN). Moreover, such network can also include hardwired and/or optical and/or wireless connection paths.

For example, by sending the message to the devices 112, 114, 116 as directed by the shared secret 150 the user can readily determine that the sender of the message is what such sender claims to be. Put differently, since the sender 140 has demonstrated knowledge of the shared secret 150 by sending the message to the communication system/device of choice as earlier identified by the user 110—a genuineness of the message is corroborated.

The connections can be shared among the devices 112, 114, 116 that can further include: personal computers, workstations, televisions, telephones, and the like, for example. Moreover, the networks can further include one or more input/output units (I/O units), wherein such I/O units can includes one or more I/O controllers connected thereto, and each of the I/O can be any of several types of I/O devices, such as storage devices (e.g., a hard disk drive, tape drive) or other I/O device. The hosts and I/O units and their attached I/O controllers and devices can be organized into groups such as clusters, with each cluster including one or more hosts and typically one or more I/O units (each I/O unit including one or more I/O controllers). The hosts and I/O units can be interconnected via a collection of routers, switches and communication links (such as wires, connectors, cables, and the like) that connects a set of nodes (e.g., connects a set of hosts and I/O units) of one or more clusters. It is to be appreciated that the wireless communication network can be cellular or WLAN communication network; such as Global System for Mobile communication (GSM) networks, Universal Mobile Telecommunication System (UMTS) networks, and wireless Internet Protocol (IP) networks such as Voice over Internet Protocol (VoIP) and IP Data networks

For example, the portable device employed by the user 110 to receive a message from the sender 140 can be a hand-held wireless communication device that can communicate with a wireless communication network, (e.g. wireless communication network) to upload and download digital information, via a cellular access point and/or via a wireless access network (WLAN) access point, such as a cellular base station, mobile switching center, 802.11x router, 802.16x router and the like. Further examples of the portable user devices can include a cellular communication device, a multi-mode cellular device, a multi-mode cellular telephone, a dual-mode cellular device, a dual-mode cellular/WiFi telephone, or like cellular and/or combination cellular/fixed internet protocol (IP) access devices.

Accordingly, the system 100 enables the user 110 to readily determine that the sender 140 of the message is what such sender 140 claims to be, since the sender has demonstrated a knowledge of the shared secret by sending the message to the communication system as determined by the user—wherein by not revealing the shared secret during communication, robustness of the secret is typically ensured. For example, the sender can supply a hint in form of an indirect suggestion or allusion (e.g., a copy of this message has been sent to second e-mail account at snoop*****@hotmail.com—without actually indicating such e-mail address); and/or in form of enabling a user to infer that the message sender knows the shared secret (e.g., calling the users cell phone twice and hanging up, contacting the first or second communication account at a predetermined time, leaving a cryptic voice mail on the user's voice mail account, send an instant message to the user or recipient.)

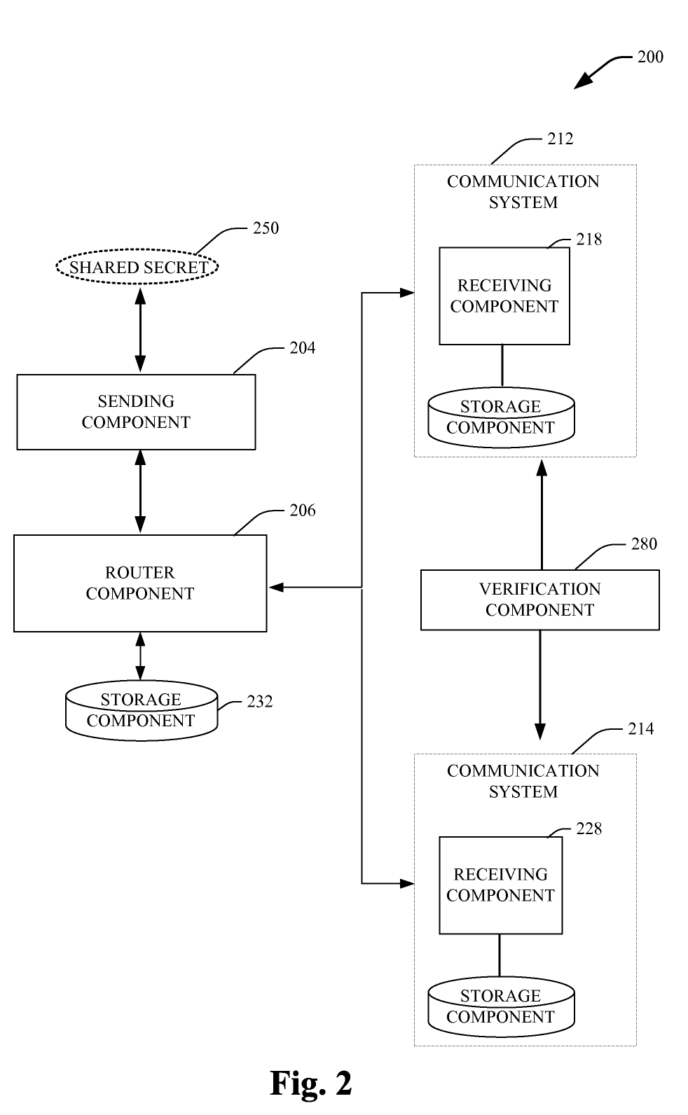

FIG. 2 illustrates an exemplary communication system 200, wherein a user can establish a plurality of communication accounts, such as two communication systems 212, 214 and/or communication accounts—such as in form of two e-mail accounts. The shared secret 250 can include instructions supplied by a user to senders of messages that if a message is sent to the first communication system 212, a same message has to be sent to second communication system 214, wherein both the communication systems 212 and 214 are under the control of the user. Accordingly, the user verifies content for both communication systems 212 and 214 before a user treats such messages as genuine.

For example, the shared secret can include transfer of the message to the second e-mail account upon transfer of such message to the first e-mail account. Accordingly, once the sender sends a message to the first e-mail account, a portion of this message can also include that such message has also been sent to the second e-mail (without actually specifying the whole address. e.g., xxxx@hotmail.com). Moreover, the sender sends the message to the second e-mail account. Such compliance with a manner the messages are sent can typically ensure genuineness of sender, since the shared secret is not readily availed to malicious entities.

A sending component 204 associated with the sender prepares messages for transmission to a router component 206 and ultimately to a receiving component 218, 228 associated with the communication systems 212, 214 respectively. For example, the message can travel to a router component 206 that couples to a storage medium 232, wherein the router component 206 handles proper transmission to the receiving component 216 and 218. Each receiving component 218, 228 can receive information from the router component 206 and/or the sending component 204 and decompress the received information through a decoder (not shown), for example. Moreover, a verification component 280 can verify that the messages are actually received by the communication systems 212 and 214. Such verification component can check the communication systems 212, 214 upon occurrence of a predetermined event and/or periodically, to determine if messages have actually been received.

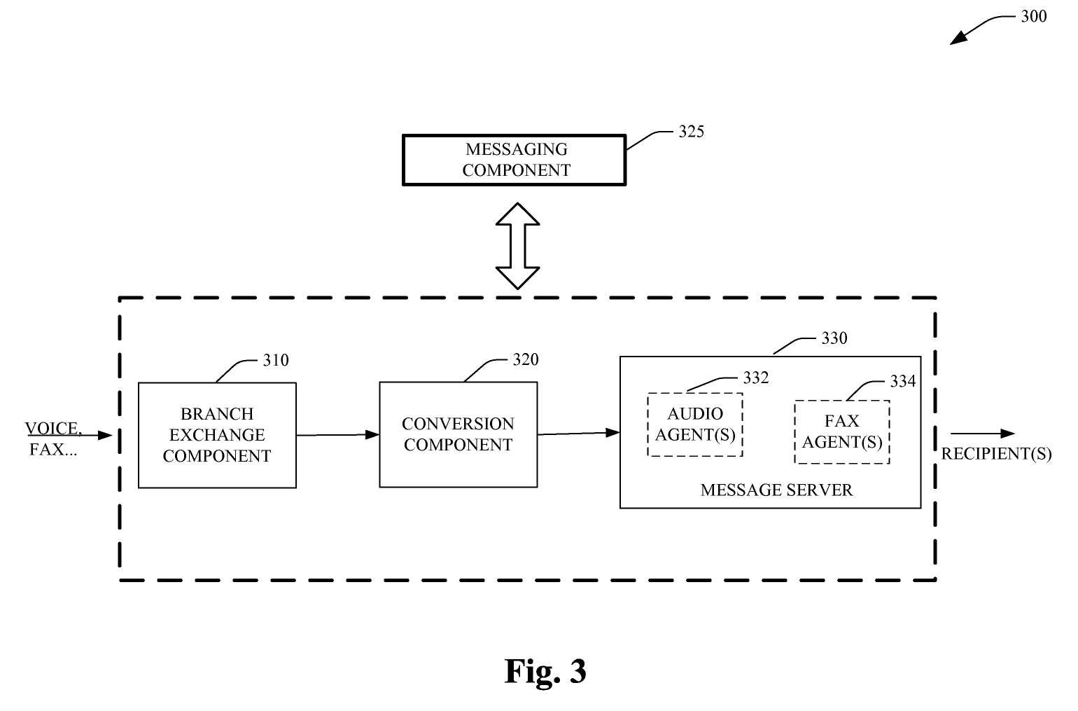

FIG. 3 illustrates a particular aspect of a system 300 that authenticates trust between sender of a message (e.g., a financial institution) and a receiver of a message (e.g., a user or client of the financial institution) according to a particular aspect of the subject innovation. For example, if the shared secret requires that the message sender leaves a message at a predetermined number (after sending an e-mail to the primary e-mail account of the user), the system 300 enables converting such voice mail to an addition e-mail being sent to the primary e-mail account of the user. Hence, the user can verify genuineness of the earlier e-mail upon receiving the subsequent e-mail from the system 300. Put differently, the system 300 can supply an additional e-mail by converting a voice and/or fax that is sent by the financial institution (sender of the message) as instructed by the shared secret.

The system 300 includes a branch exchange component 310 that acquires voice communications, and can include an Intranet protocol (IP) branch exchange (IPBX). Furthermore, the branch exchange component 310 can be public (e.g., central office exchange service) or private (PBX). Accordingly, the branch exchange component 310 can receive communications from conventional telephone systems or over the Internet, among others, via a telephone protocol, IP protocol (e.g., H.323, SIP . . . ) or any other public or proprietary protocol. Upon receipt of a communication the branch exchange component 310 can route the communication to the conversion component 320. For example, the branch exchange component 310 can forward a call that was not answered or a phone number configured to answer a fax to the conversion component 320. The conversion component 320 can receive a communication from the branch exchange component 310 (or via a connection provided thereby), and such conversion component 320 can convert the received communication to an email. For example, the communications can subsequently or concurrently be transformed into an SMTP (Simple Mail Transfer Protocol) message. As illustrated, the system 300 can interact with the messaging component 325 that follows the direction as specified in the shared secret between the user and the message sender.

In a related aspect, the voice or facsimile message can be also be recorded or saved and provided as an attachment to the e-mail generated by the system 300. Furthermore, a portion of the content of the message can be encoded in the body, for instance in a MIME (Multipurpose Internet Mail Extension) format. Additional information can also be captured in the body such as message type (e.g. voice, fax), calling telephone number, voice message duration, voice message sender name, attachment name, fax number of pages and the like. Moreover, the MIME message can subsequently be converted into an internal representation, which can be stored with an internal representation of a message classification.

In a related aspect, the conversion component 320 can also be extensible, to employ third party and/or non-native functionality, for instance provided by plug-in components (not shown). For example, such plug-in component can provide algorithms to facilitate translating speech-to-text or for optical character recognition, and hence not all functionality need to be provided solely by the conversion component 320. Accordingly, the conversion component 320 can be updated such that it can employ suitable techniques or mechanisms associated with email generation as part of the system 300, for example.

In one aspect, a generated email or SMTP message can be transmitted from the conversion component 320 to the message server 330. The message server 330 can process messages for delivery to an intended recipient mailbox(es), among other things, such that they can be received or retrieved by an email application (e.g., viewer/editor and POP or IMAP client). For example, the server 330 can correspond to a mailbox, SMTP and/or a bridgehead server. It should also be appreciated that the conversion component 320 can be an SMTP client that communicates with the SMTP server. In addition to forwarding messages to a recipient's mailbox or mailboxes, the message server 330 can filter such messages.

The message server 330 can employ audio agents 332 to scan the audio rather than the text preview of the message. Such audio agents 332 can evaluate based on tone of voice, volume, and/or word checking, among other things. Similarly, fax agents 334 can scan the structure of the email separate from the converted structured document or preview. It should also be noted that the agents 332 and 334 can be plug-ins or add-ons produced by the server vendor or third-party vendors, among others. As explained earlier, trust can then be established between a user and a sender of a message by authenticating such sender through demonstration of knowledge for s shared secret (e.g., predetermined)—yet without revealing such secret—through the messaging component 325.

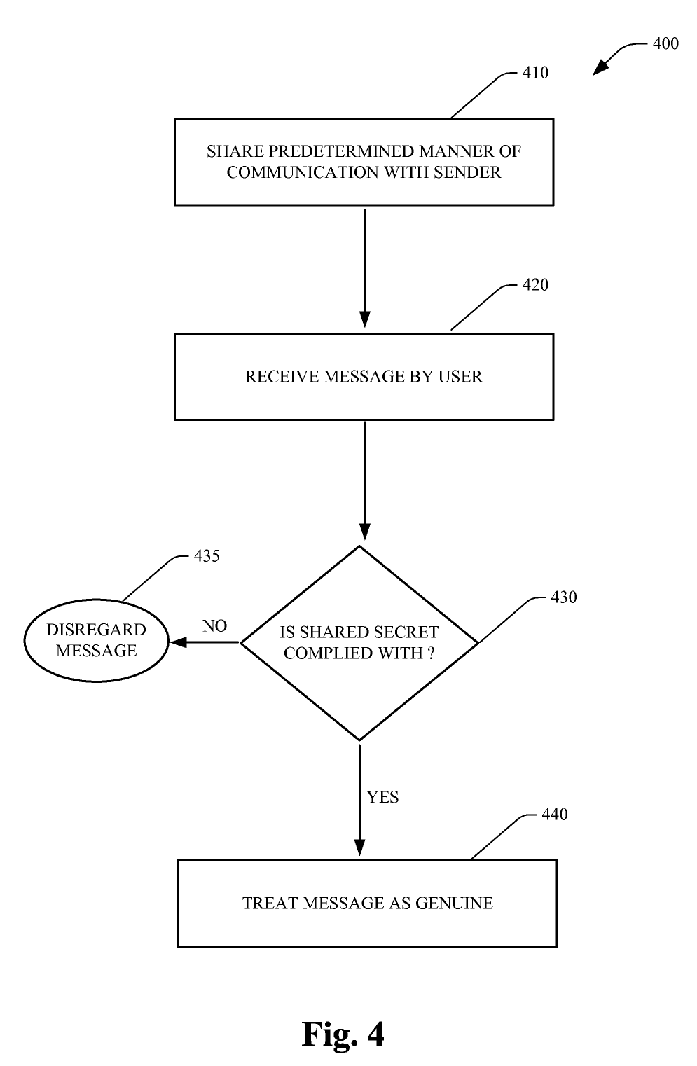

FIG. 4 illustrates a related methodology 400 of establishing trust between a sender of a message and a receiver of a message (e.g., a user) in accordance with an aspect of the subject innovation. While the exemplary method is illustrated and described herein as a series of blocks representative of various events and/or acts, the subject innovation is not limited by the illustrated ordering of such blocks. For instance, some acts or events may occur in different orders and/or concurrently with other acts or events, apart from the ordering illustrated herein, in accordance with the innovation. In addition, not all illustrated blocks, events or acts, may be required to implement a methodology in accordance with the subject innovation. Moreover, it will be appreciated that the exemplary method and other methods according to the innovation may be implemented in association with the method illustrated and described herein, as well as in association with other systems and apparatus not illustrated or described.

According to the methodology 400 of the subject innovation, at 410 the user can share a predetermined manner of communication with the sender of the message. As explained earlier, the sender of the message can be an institution that the user or message receiver can be a client thereof. Such predetermined manner of communication between the message sender and user can be deemed a shared secret between the user and sender. Subsequently and at 420, the message can be received by the user. Upon receipt of such message, a verification is subsequently performed at 430 to check whether the shared secret has been complied with. If so, the methodology 400 proceeds to act 440, wherein the received message is treated as genuine. Otherwise, the message is disregarded at 435. It is to be appreciated that the shared secret can be updated by the user (e.g., via registering a new shared secret with the message sender.)

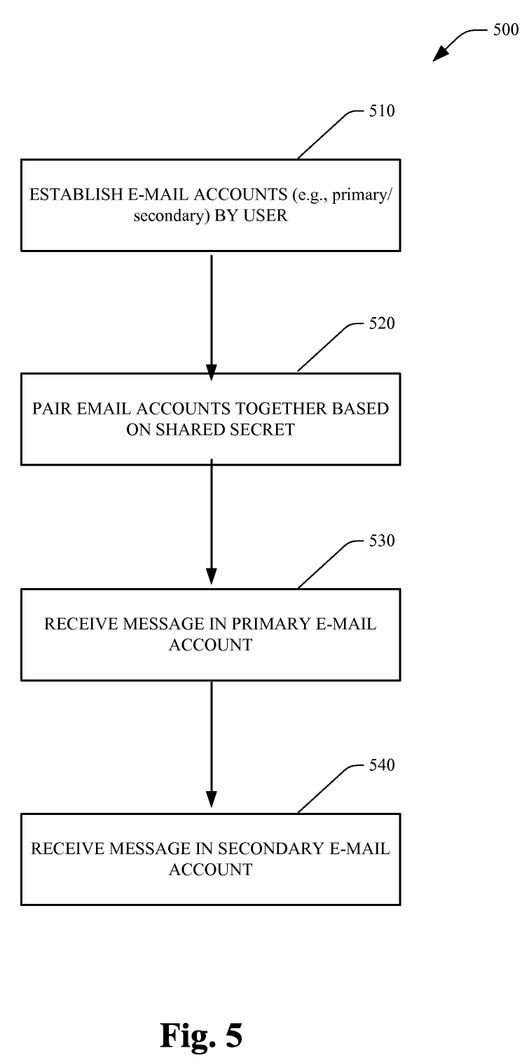

FIG. 5 illustrates a related methodology 500 of sender authentication according to a further aspect of the subject innovation. Initially at 510, the user establishes e-mail accounts with an internet service provider, for example. Hence, in such particular aspect—the subject innovation is based on the user having more than one email account, wherein a malicious party cannot readily determine that two email accounts belong to the same person. As such, rather than record an email account with the message sender (e.g., financial institution) the user records two accounts namely a primary e-mail (account A); and a secondary e-mail (account B)—wherein such e-mails can than be paired together at a sender side for contacting the user, based on the shared secret.

Hence, to send a trusted message the institution sends the e-mail to both accounts A and B. In the subject line of the message (e.g., as part of a segment of the message) to A the institution can embed a message “A copy of this message has been sent to h(B),” and in the subject line of the message to B the institution embeds a message “A copy of this message has been sent to h(A).” Here h( ) is a function (e.g., a hash function, or obtained thru a mapping) that denotes part of the address. For example if A=snoopy2314@hotmail.com, the e-mail can have h(A)=snoop*****@hotmail.com. Such reveals that the sender knows the other email address without revealing the address itself. Moreover, the recipient can check that a copy indeed has been sent to the account in question. As such, replay becomes difficult, wherein an attacker who observes a message in the inbox of A knows enough to forge the subject line, but not enough to have a message also appear in the mailbox of B. Thus even if both A and B both exist on a list that a spammer is employing, such malicious party cannot mimic an email from the real institution without knowledge of which emails are paired together. Upon receiving the message at 530 in the primary e-mail account A, the user is in a position to verify that the sender knows the secret, but the secret is not itself revealed. Next and at 540, receipt of the message in the secondary e-mail account can be verified, wherein the user can check that mailbox B contains a copy of the message. Alternatively, the user can forward the email from B to A so that both arrive at the same mailbox; thus the user is in a position to verify that the sender knows the secret, while the secret has not been revealed to anyone who observes either of the messages in transit.

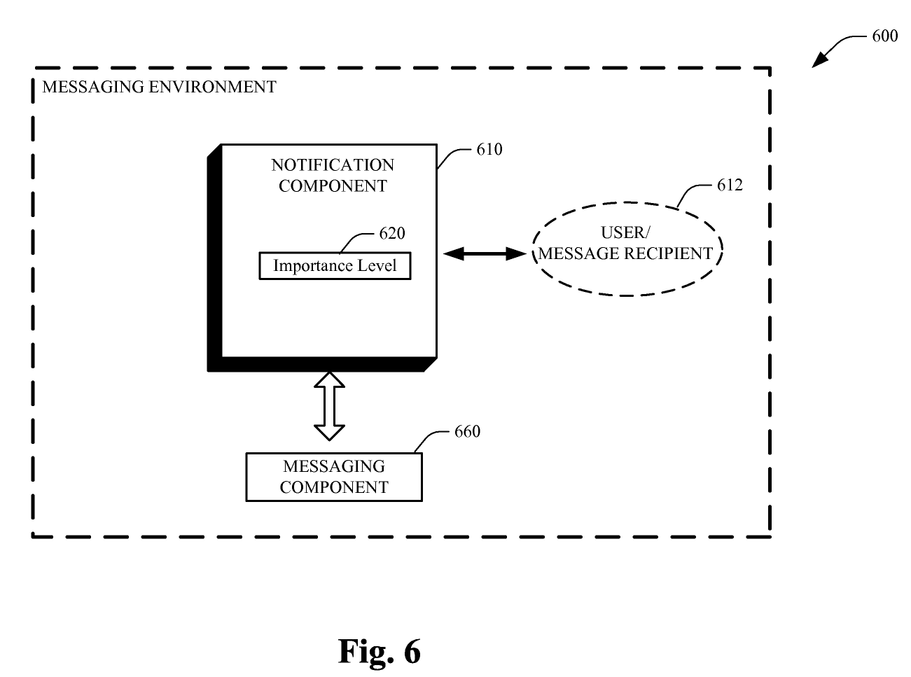

FIG. 6 illustrates a particular block diagram for a system 600 that includes notification component 610, which is associated with a messaging component 660 of the subject innovation. The notification component 610 can transmit an alert to the user 612 and/or end point regarding receipt of an e-mail and/or communication from the message sender in accordance with an aspect of the subject innovation. In addition, the notification component 610 can set various levels of importance 620 to the message sender based on an importance thereof to the user. Such notification can be provided in synchronous manner and in form of an instant message, which indicates to the user that e-mail has been received. The notice for receipt of a message in an e-mail inbox can be in form of a telephone call initiation, instant message, and the like wherein the user is notified regarding receipt of the message.

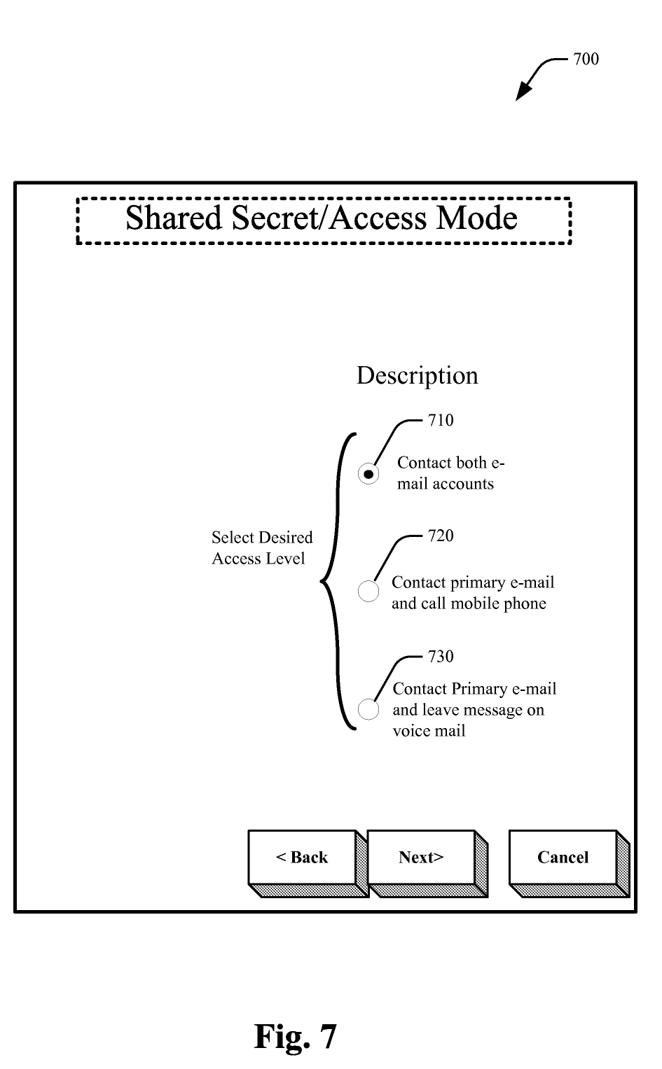

FIG. 7 illustrates an exemplary graphical user interface (GUI) 700 at the sender side, which displays desired manner of communication and/or the shared secret as designated by a user who subsequently receives the message. As illustrated, the user can select option 710, and hence instruct the messaging component to contact both e-mail accounts and send messages to both such accounts. As explained in detail supra, the shared secret can include transfer of the message to the second e-mail account upon transfer of such message to the first e-mail account. Likewise, option 720 enables the user to designate the shared secret as sending an intended message to the primary e-mail and also calling the mobile phone.

Similarly, option 730 provides for designation of the shared secret as contacting the primary e-mail of the user, and also leaving a message on user's voice mail at predetermined number. Accordingly, depending on such designated context and/or shared secret, a user is notified of impending communications defined by the context and one or more policies/rules for verifying genuineness of messages being sent. Put differently, decision-making policies employed for communication are generally refined and personalized according to a set of nominal settings that are initially defined by users, who receive such messages.

Moreover, such personalization capabilities enhance value of these systems—wherein users can readily manipulate, control, and thereby personalize manner for communication processes. It is to be appreciated that default settings can also be provided to enable predetermined settings consistent with a particular type of user (e.g., busy office worker, road worker, home worker). As the user becomes accustomed to the amount and/or frequency of communications and related notifications, a tuning system (not shown) can be supplied to modify and adjust particular contexts and/or subsets of messaging variables to facilitate personalization and refinement of the communication system.

The word “exemplary” is used herein to mean serving as an example, instance or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner. It is to be appreciated that a myriad of additional or alternate examples could have been presented, but have been omitted for purposes of brevity.

Furthermore, all or portions of the subject innovation can be implemented as a system, method, apparatus, or article of manufacture using standard programming and/or engineering techniques to produce software, firmware, hardware or any combination thereof to control a computer to implement the disclosed innovation. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

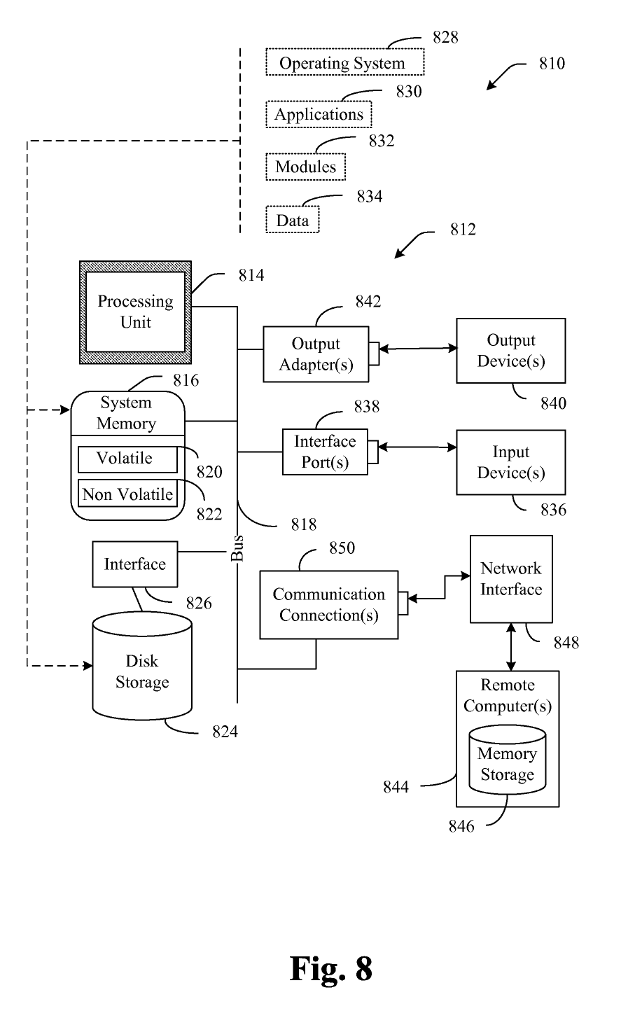

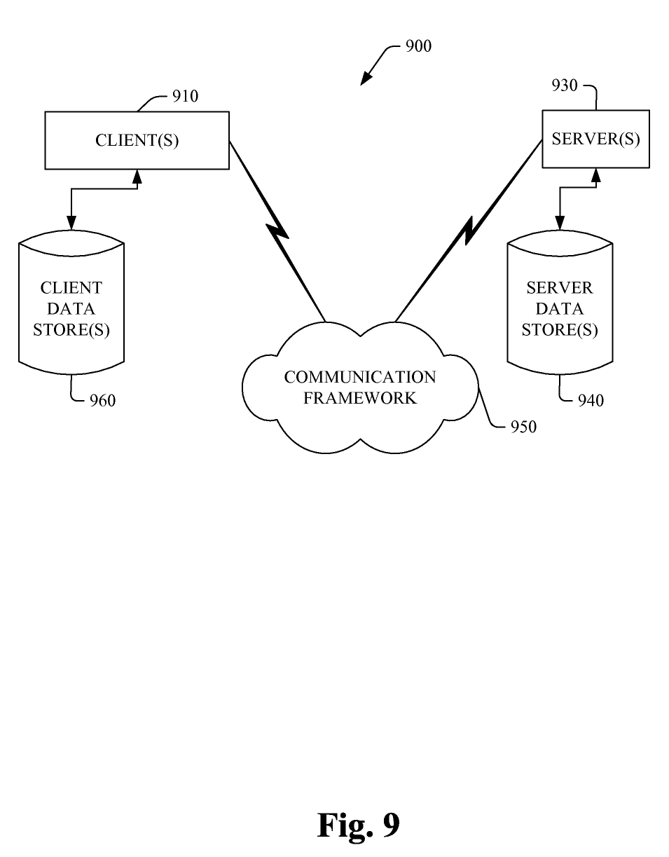

In order to provide a context for the various aspects of the disclosed subject matter, FIGS. 8 and 9 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the innovation also may be implemented in combination with other program modules. Generally, program modules include routines, programs, components, data structures, and the like, which perform particular tasks and/or implement particular abstract data types. Moreover, those skilled in the art will appreciate that the innovative methods can be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the innovation can be practiced on stand-alone computers. In a distributed computing environment, program modules may be located in both local and remote memory storage devices.

With reference to FIG. 8, an exemplary environment 910 for implementing various aspects of the subject innovation is described that includes a computer 812. The computer 812 includes a processing unit 814, a system memory 816, and a system bus 818. The system bus 818 couples system components including, but not limited to, the system memory 816 to the processing unit 814. The processing unit 814 can be any of various available processors. Dual microprocessors and other multiprocessor architectures also can be employed as the processing unit 814.

The system bus 818 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 816 includes volatile memory 820 and nonvolatile memory 822. The basic input/output system (BIOS), containing the basic routines to transfer information between elements within the computer 812, such as during start-up, is stored in nonvolatile memory 822. By way of illustration, and not limitation, nonvolatile memory 822 can include read only memory (ROM), programmable ROM (PROM), electrically programmable ROM (EPROM), electrically erasable ROM (EEPROM), or flash memory. Volatile memory 820 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 812 also includes removable/non-removable, volatile/nonvolatile computer storage media. FIG. 8 illustrates a disk storage 824, wherein such disk storage 824 includes, but is not limited to, devices like a magnetic disk drive, floppy disk drive, tape drive, Jaz drive, Zip drive, LS-60 drive, flash memory card, or memory stick. In addition, disk storage 824 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 824 to the system bus 818, a removable or non-removable interface is typically used such as interface 826.

It is to be appreciated that FIG. 8 describes software that acts as an intermediary between users and the basic computer resources described in suitable operating environment 810. Such software includes an operating system 828. Operating system 828, which can be stored on disk storage 824, acts to control and allocate resources of the computer system 812. System applications 830 take advantage of the management of resources by operating system 828 through program modules 832 and program data 834 stored either in system memory 816 or on disk storage 824. It is to be appreciated that various components described herein can be implemented with various operating systems or combinations of operating systems.

A user enters commands or information into the computer 812 through input device(s) 836. Input devices 836 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 814 through the system bus 818 via interface port(s) 838. Interface port(s) 838 include, for example, a serial port, a parallel port, a game port, and a universal serial bus (USB). Output device(s) 840 use some of the same type of ports as input device(s) 836. Thus, for example, a USB port may be used to provide input to computer 812, and to output information from computer 812 to an output device 840. Output adapter 842 is provided to illustrate that there are some output devices 840 like monitors, speakers, and printers, among other output devices 840 that require special adapters. The output adapters 842 include, by way of illustration and not limitation, video and sound cards that provide a means of connection between the output device 840 and the system bus 818. It should be noted that other devices and/or systems of devices provide both input and output capabilities such as remote computer(s) 844.

Computer 812 can operate in a networked environment using logical connections to one or more remote computers, such as remote computer(s) 844. The remote computer(s) 844 can be a personal computer, a server, a router, a network PC, a workstation, a microprocessor based appliance, a peer device or other common network node and the like, and typically includes many or all of the elements described relative to computer 812. For purposes of brevity, only a memory storage device 846 is illustrated with remote computer(s) 844. Remote computer(s) 844 is logically connected to computer 812 through a network interface 848 and then physically connected via communication connection 850. Network interface 848 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 850 refers to the hardware/software employed to connect the network interface 848 to the bus 818. While communication connection 850 is shown for illustrative clarity inside computer 812, it can also be external to computer 812. The hardware/software necessary for connection to the network interface 848 includes, for exemplary purposes only, internal and external technologies such as, modems including regular telephone grade modems, cable modems and DSL modems, ISDN adapters, and Ethernet cards.

FIG. 9 is a schematic block diagram of a sample-computing environment 900 that can be employed as part of trust establishment in accordance with an aspect of the subject innovation. The system 900 includes one or more client(s) 910. The client(s) 910 can be hardware and/or software (e.g., threads, processes, computing devices). The system 900 also includes one or more server(s) 930. The server(s) 930 can also be hardware and/or software (e.g., threads, processes, computing devices). The servers 930 can house threads to perform transformations by employing the components described herein, for example. One possible communication between a client 910 and a server 930 may be in the form of a data packet adapted to be transmitted between two or more computer processes. The system 900 includes a communication framework 950 that can be employed to facilitate communications between the client(s) 910 and the server(s) 930. The client(s) 910 are operatively connected to one or more client data store(s) 960 that can be employed to store information local to the client(s) 910. Similarly, the server(s) 930 are operatively connected to one or more server data store(s) 940 that can be employed to store information local to the servers 930.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims.

Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer implemented method comprising:
defining a shared secret between a sender and recipient of a message; the shared secret associated with capability of the recipient to access a first communication account and a second communication account; and
hinting sender's knowledge of the second communication account, when sending a message to the first communication account.

2. The computer implemented method of claim 1, the hinting act further employs a hash function that reveals partial information for the first or second communication accounts.

3. The computer implemented method of claim 1, the hinting act further comprising enabling the recipient to infer that sender has knowledge of the shared secret.

4. The computer implemented method of claim 1 further comprising converting speech to text.

5. The computer implemented system of claim 2 further comprising demonstrating knowledge of the shared secret without revelation thereof.

6. The computer implemented system of claim 1 further comprising leaving a voice mail by the sender upon sending an e-mail message, or sending an instant message, or a combination thereof.

7. The computer implemented system of claim 2 further comprising pairing the first and second communication accounts.

8. The computer implemented system of claim 2 further comprising designating an e-mail account as a primary account.

9. The computer implemented system of claim 1 further comprising verifying compliance with the shared secret.

10. The computer implemented system of claim 1 further comprising including in a portion of the message indication that the message has been sent to both communication accounts.

11. A computer implemented system comprising the following computer executable components:
a user interface component that receives a shared secret defined between a sender and recipient of a message, the shared secret associated with capability of the recipient to access a first communication account and a second communication account; and
a messaging component that hints to the recipient awareness regarding the shared secret.

12. The computer implemented system of claim 11, the first communication account and the second communication account are selected from a group of e-mail, voice mail, fax, instant messaging, text messaging, or telephone.

13. The computer implemented system of claim 11 further comprising a mapping function that reveals partial information for one of the first or second communication accounts.

14. The computer implemented system of claim 11, the user interface component with an importance level designation for the message.

15. The computer implemented system of claim 11 further comprising a verification component that verifies compliance with the shared secret.

16. The computer implemented system of claim 11 further comprising a conversion component that converts speech to text.

17. The computer implemented system of claim 11, the message with a segment for identification of one of the first or second communication accounts.

18. The computer implemented system of claim 11 further comprising a registration component for registration of the shared secret.

19. The computer implemented system of claim 12 further comprising a sending component that sends a message to two e-mail accounts.

20. A computer implemented system comprising the following computer executable components:
means for conveying messages to communication systems by demonstrating knowledge of a shared secret and without a revelation thereof; and
means for receiving the messages in the communication systems.
